(19) United States
(12) Patent Application Publication
(10) Pub. No.: US 2009/0176082 A1
(43) Pub. Date: Jul. 9, 2009

(54) ELECTRICALLY CONDUCTING GASKET, METHOD OF MANUFACTURE THEREOF AND ARTICLES COMPRISING THE SAME

(75) Inventor: Joseph Kuczynski, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/968,978

(22) Filed: Jan. 3, 2008

(51) Int. Cl. B32B 3/26

(52) U.S. Cl. 428/304.4

(57) ABSTRACT

Disclosed herein is a gasket comprising a core foam; the core foam is electrically insulating having a surface electrical resistivity of greater than or equal to about 10¹² ohm-cm; and an electrically conducting foamed layer that comprises carbon nanotubes disposed on the core foam and integral with the core foam; the electrically conducting foamed layer having a surface electrical resistivity of less than or equal to about 10⁹ ohm-cm; the carbon nanotubes being embedded in the electrically conducting foamed layer.

### BACKGROUND

This disclosure relates to electrically conducting gaskets, methods of manufacture thereof and articles comprising the same.

The primary function of an electrically conducting gasket (also commonly known as an electromagnetic compatibility (EMC) gasket) is to provide a conductive path across the seam that is used in a housing that contains electrical or electronic equipment (hereinafter electronic equipment). The housing generally comprises an electronic equipment housing and a cover or door that is disposed on the equipment housing. The EMC gasket is disposed between the equipment housing and the door to prevent electromagnetic radiation from leaking through that seam between the door and the equipment housing. The EMC gasket prevents internally generated electromagnetic radiation in the radio frequency and microwave range from escaping the equipment housing to interfere with the electromagnetic radiation being received by nearby electronic equipment. It also prevents externally generated electromagnetic radiation in the radio frequency and microwave range from entering a particular system and possibly affecting its functionality.

Commercially available fabric-over-foam core EMC gaskets as depicted in the FIG. 1 utilize a foam core having a metallized fabric that is disposed thereon and are attached to a conductive substrate with a narrow strip of non-electrically conducting pressure sensitive adhesive (PSA). EMC gasket manufacturers have experimented with the development of electrically conducting PSAs made by adding metallic particle fillers to the PSA. However, while the resulting PSA has improved electrical properties, the gasket's adhesive bond strength has been substantially reduced. To compensate for the lower bond strength of a metal particle filled PSA, the PSA strip applied to the EMC gasket would have to be significantly widened, which would deleteriously affect the ability of the gasket to prevent the ingress and egress of electromagnetic radiation. To date, few commercially available EMC gaskets that have a conductive PSA bond are available and all of these use conductive particle filled PSAs. It is therefore desirable to have an EMC gasket that does not have to employ a PSA.

### SUMMARY

Disclosed herein is a gasket comprising a core foam; and an electrically conducting foamed layer that comprises carbon nanotubes disposed on the core foam and integral with the core foam; the electrically conducting foamed layer having a surface electrical resistivity of less than or equal to about 10⁹ ohm-cm; the carbon nanotubes being embedded in the electrically conducting foamed layer and wherein the core foam is electrically insulating having a surface electrical resistivity of greater than or equal to about 10¹² ohm-cm.

Disclosed herein too is a method comprising disposing a foam in a container; the foam comprising an electrically insulating organic polymer; the container comprising a bed of carbon nanotubes; the carbon nanotubes being maintained at a temperature proximate to the glass transition temperature of the organic polymer; disposing the carbon nanotubes on a surface of the foam; and embedding the carbon nanotubes into an outer layer of the foam to form a electrically conducting foamed layer; the electrically conducting foamed layer having a surface electrical resistivity of less than or equal to about 10⁹ ohm-cm.

Disclosed herein too is an article manufactured by the aforementioned method. Disclosed herein too is an article that comprises the aforementioned electromagnetic compatibility gasket.

### BRIEF DESCRIPTION OF FIGURES

FIG. 1 is an exemplary depiction of one method that can be used to coat the foam with carbon nanotubes;

FIG. 2 is another exemplary depiction of another method that can be used to coat the foam with carbon nanotubes; in this method the carbon nanotubes are directly coated in a reactor used to produce the carbon nanotubes; and

FIG. 3 is an exemplary depiction of a section of an electromagnetic compatibility gasket that comprises a foam having an electrically conducting layer disposed thereon; the electrically conducting layer comprising the carbon nanotubes embedded therein.

### DETAILED DESCRIPTION

Disclosed herein is an electrically conducting foam that comprises an electrically insulating core that has disposed upon it an electrically conducting foamed layer that comprises an electrically conducting filler. The electrically insulating core and the electrically conducting foamed layer are part of a single piece of foam, i.e., they are seamlessly integrated. In an exemplary embodiment, the electrically conducting filler comprises carbon nanotubes. The carbon nanotubes are embedded into the outer surface of the foam and form an electrically conducting network on the outer surface of the foam. The electrically conducting network provides electrical connectivity between the door and the housing of a device that houses electronic equipment when the electrically conducting foam is used as an electromagnetically compliant gasket between the door and the housing. The electromagnetically compliant gasket can provide shielding against electromagnetic radiation and displays a shielding effectiveness of about 40 dB (decibels) to about 100 dB.

Disclosed herein too is a method of manufacturing the electrically conducting foam. The method comprises disposing the foam in a container that comprises the electrically conducting filler at an elevated temperature that is close to the glass transition temperature of the organic polymer used to form the foam. The raising of the temperature of the foam to a temperature near the glass transition temperature causes the organic polymer to become soft. The foam is then depressed or rolled into the electrically conducting filler to form an electrically conducting layer on the outside. During the rolling of the foam into the electrically conducting filler, the electrically conducting filler gets embedded into the outer layer of the foam in proportions effective to render the outer layer electrically conducting.

The foam is generally manufactured from an organic polymer. The organic polymer may be selected from a wide variety of thermoplastic polymers, thermosetting polymers, blend of thermoplastic polymers, or blends of thermoplastic polymers with thermosetting polymers. The organic polymer may also be a blend of polymers, copolymers, terpolymers, or combinations comprising at least one of the foregoing organic polymers. Examples of the organic polymer are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyvinyl ethers, polyvinyl thioethers, polyvinyl alcohols, polyvinyl ketones, polyvinyl halides, polyvinyl nitrites, polyvinyl esters, or the like, or a combination comprising at least one of the foregoing organic polymers.

Examples of thermosetting organic polymers include polyurethane, natural rubber, synthetic rubber, epoxy, phenolic, polyesters, polyamides, silicones, or the like, or combinations comprising at least one of the foregoing thermosetting polymers. Blends of thermosetting polymers as well as blends of thermoplastic polymers with thermosets can be utilized. The foam can comprise an open cell foam, a closed cell foam, or a combination of an open cell foam with a closed cell foam. The organic polymer is electrically insulating prior to its immersion in the carbon nanotubes. The organic polymer has a surface electrical resistivity that is greater than or equal to about 10¹² ohm-cm.

In an exemplary embodiment, the electrically conducting fillers can be carbon nanotubes. Carbon nanotubes may be single wall carbon nanotubes (SWNTs), multiwall carbon nanotubes (MWNTs), or vapor grown carbon fibers (VGCF). These SWNTs generally have a single wall comprising a graphene sheet with outer diameters of about 0.7 to about 2.4 nanometers (nm). MWNTs have at least two graphene layers bound around an inner hollow core. MWNTs generally have diameters of about 2 to about 50 nm. VGCF or partially graphitic carbon fibers having diameters of about 3.5 to about 100 nanometers (nm) and an aspect ratio greater than or equal to about 5 may also be used. When carbon nanotubes are used, it is desirable to have an average aspect ratio greater than or equal to about 5, specifically greater than or equal to about 100, and more specifically greater than or equal to about 1,000. The carbon nanotubes may be functionalized if desired.

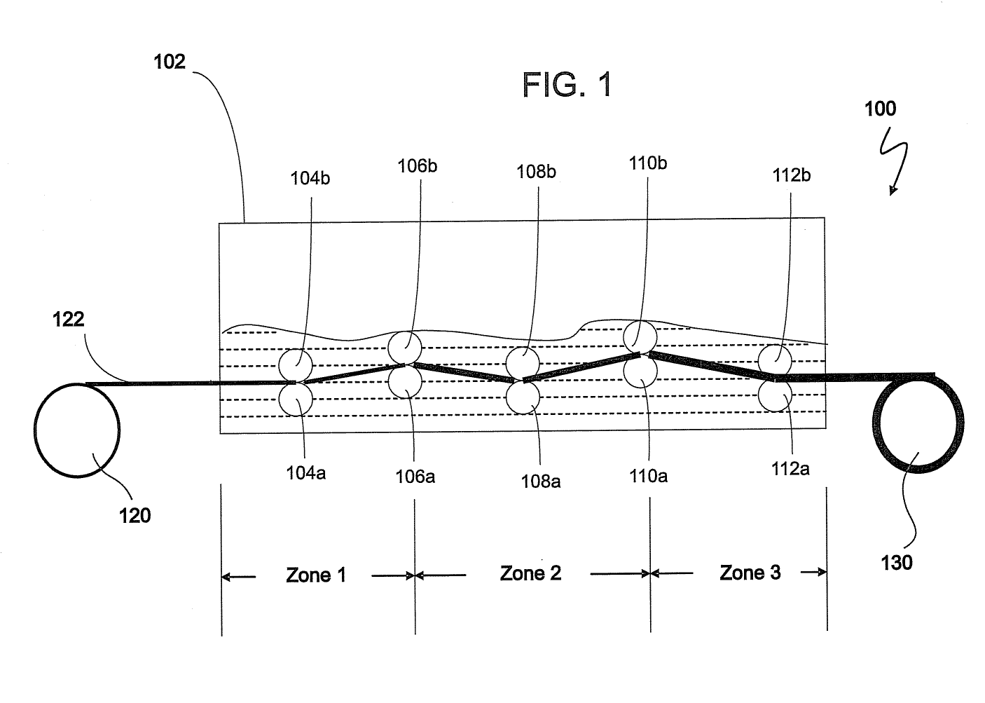

In one embodiment, in one exemplary maimer of proceeding, a length of foam is permitted to traverse a bed of carbon nanotubes that are held at an elevated temperature that is close to the glass transition temperature of the foam. FIG. 1 depicts a system 100 comprising a container 102 with a plurality of rollers pairs 104a, 104b; 106a, 106b; 108a, 108b; and the like, dispersed therein. While the FIG. 1 depicts five pairs of roller pairs, a single roller pair may be used or alternatively up to twenty roller pairs may be used.

Each roller pair is spring loaded, i.e., the roller 104a has a spring that acts to force the roller 104a against the roller 104b. In a similar manner, the roller 104b has a spring that acts to force the roller 104b against the roller 104a.

The foam 122 is mounted around two rolls, a first roll 120 and a second roll 130; the rolls being disposed at opposing ends of the container 102. During the process of coating the outer surface of the foam 122 with a layer of carbon nanotubes, the foam 122 is unwound from the first roll 120, coated with the carbon nanotubes in the container 102 and then wound onto the second roll 130. An optional cooling device such as, for example, a water cooler (not shown) may be disposed between the container 102 and the second roll 130. The foam 122, after emanating from the container 102 may be cooled in the cooling device prior to being wound on the second roll 130.

As noted above, the foam 102 is heated to a temperature that is proximate to the glass transition temperature of the organic polymer used in the foam. In one embodiment, the container may be divided into a plurality of zones having different temperatures. For example, the first zone may be held at a temperature slightly below the glass transition temperature of the organic polymer used in the foam 122, the second zone may be held at the glass transition temperature of the organic polymer used in the foam 122, while the third zone may be held at a temperature that is slightly greater than the glass transition temperature of the foam 122. As the foam travels through the heated bed of carbon nanotubes, the skin of the foam 122 is generally at a higher temperature than the core of the foam 122. Thus even when the foam passes through a zone that has a temperature greater than the glass transition temperature of the foam, it is anticipated that sections of the foam will be maintained at temperatures that are lower than the glass transition temperature. During the passage of the foam through the container, the bed of nanotubes may be agitated to effect the mixing and embedding of the carbon nanotubes within the outer surface of the foam.

As the foam 122 travels through the container, its outer surface is softened as a result of the elevated temperature of the carbon nanotubes. The softening of the outer surface increases its tackiness, which causes carbon nanotubes to attach to the outer surface of the foam 122. As the foam 122 passes through the rolls, the carbon nanotubes that are attached to the outer surface of the foam 122 are depressed into the outer layer of the foam 122 by the compressive forces applied to the foam 122 by the rolls. Other conductive additives such as carbon black, metal particles, or the like, may be added to the bed of carbon nanotubes.

After leaving the container, the foam with an outer layer comprising carbon nanotubes is wound around the second roller 130. The foam may be used in an electromagnetic compatibility gasket, if desired.

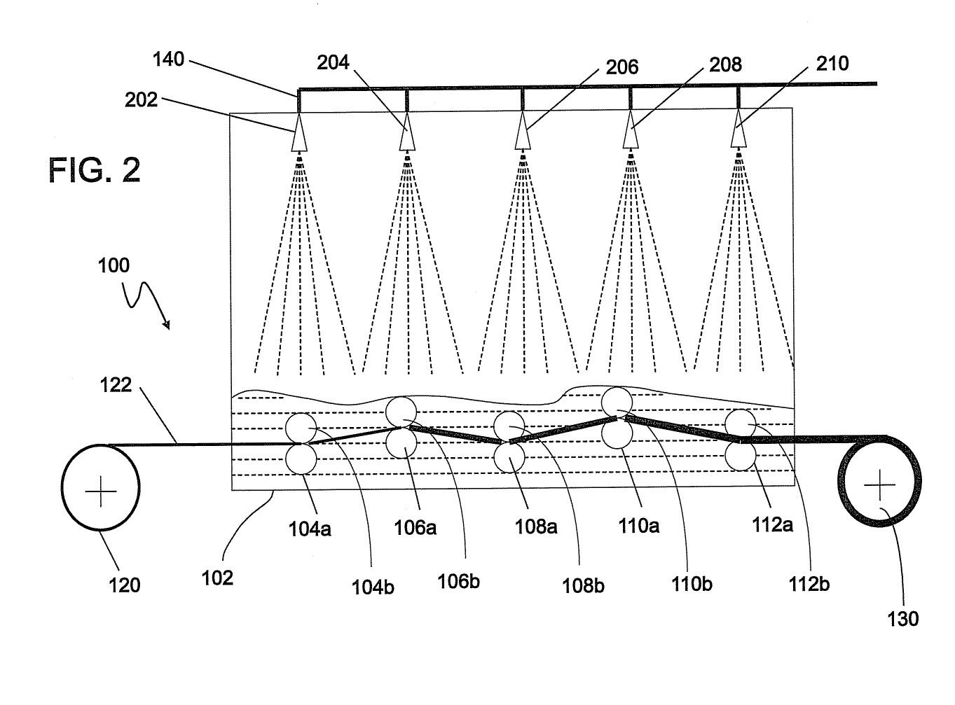

In another embodiment, in another maimer of manufacturing the electromagnetic compatibility gasket, the container 102 with the roller pairs may be disposed at the opposing end of a reactor that produces carbon nanotubes. This embodiment is depicted in the FIG. 2. In this embodiment, the container 102 is a reaction vessel that is used to produce carbon nanotubes. The container 102 comprises spray nozzles 202, 204, 206, 208 and 210 that are used to disperse a catalyst that is used for producing carbon nanotubes. A suitable catalyst is iron pentacarbonyl.

A reactive gas that comprises carbon-containing compounds is also introduced into the container via an entry port (not shown). Suitable carbon-containing compounds are hydrocarbons, including aromatic hydrocarbons, e.g., benzene, toluene, xylene, cumene, ethylbenzene, naphthalene, phenanthrene, anthracene or the like, or a combination comprising at least one of the foregoing aromatic hydrocarbons; non-aromatic hydrocarbons, e.g., methane, ethane, propane, ethylene, propylene, acetylene, or the like, or a combination comprising at least one of the foregoing non-aromatic hydrocarbons; and oxygen-containing hydrocarbons, e.g. formaldehyde, acetaldehyde, acetone, methanol, carbon monoxide, ethanol or mixtures thereof; or the like, or a combination comprising at least one of the foregoing oxygen-containing aromatic hydrocarbons. Hydrogen gas may be introduced into the container 102 if desired.

The reactive gas generally is catalyzed by the iron pentacarbonyl to produce carbon nanotubes. The carbon nanotubes generally descend to the bottom container to form a bed of carbon nanotubes. The distance between the spray nozzles and the bottom of the container may be adjusted to effect a desired cooling of the carbon nanotubes. As noted above, it is desirable to have the carbon nanotubes at a temperature proximate to the glass transition temperature of the organic polymer used to form the foam. The distance between the spray nozzles and the bottom of the container can be adjusted so that the temperature of the carbon nanotubes is reduced during their travel from the spray nozzles to the bottom or the container, such that when they arrive at the bottom of the container, they have a temperature proximate to the glass transition temperature of the organic polymer used in the foam.

The bottom of the container may be provided with additional external heating if desired. As detailed above in the FIG. 1, the container may have a plurality of zones where different heating temperatures are used. As the foam 122 traverses the container 102, it passes through the roller pairs and carbon nanotubes are embedded into the outer layer of the foam to form an outer conductive layer as detailed above.

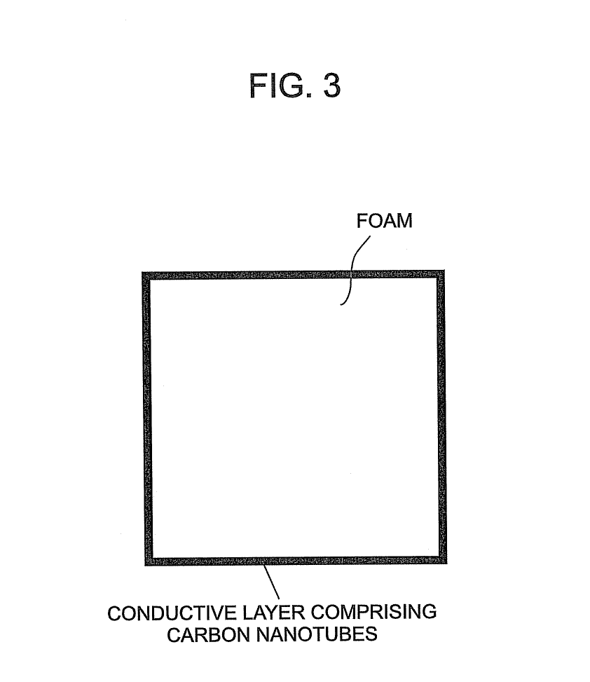

As can be seen in the FIG. 3, the outer conductive layer of the foam comprises carbon nanotubes and can provide an electrically conductive pathway between the door and the electrical housing when the carbon nanotube coated foam is used as a gasket.

The outer conductive layer of the foam generally has a surface electrical resistivity of less than or equal to about 10¹² ohm-cm, specifically less than or equal to about 10⁹ ohm-cm, specifically less than or equal to about 10⁵ ohm-cm, and more specifically less than or equal to about 10³ ohm-cm.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. A gasket comprising:
a core foam; the core foam is electrically insulating having a surface electrical resistivity of greater than or equal to about 10¹² ohm-cm; and
an electrically conducting foamed layer that comprises carbon nanotubes disposed on the core foam and integral with the core foam; wherein the electrically conducting foamed layer and the core foam are part of a single piece of foam; the electrically conducting foamed layer comprising carbon nanotubes in an amount effective to provide a surface electrical resistivity of less than or equal to about 10⁹ ohm-cm; the carbon nanotubes being embedded in the electrically conducting foamed layer.

2. An article comprising the gasket of claim 1.
